(19) United States
(12) Patent Application Publication
(10) Pub. No.: US 2021/0007323 A1
(43) Pub. Date: Jan. 14, 2021

(54) FEEDING DEVICE

(71) Applicant: Al J. Curry, Kemah, TX (US)

(72) Inventor: Al J. Curry, Kemah, TX (US)

(21) Appl. No.: 16/504,479

(22) Filed: Jul. 8, 2019

(51) Int. Cl. A01K 5/01; A01K 5/02

(52) U.S. Cl. CPC A01K 5/01; A01K 5/001; A01K 5/02

(57) ABSTRACT

A device for remote feeding of animals, particularly marine animals, such as sharks. The device which can be used over and over again, and makes it possible to control the rate at which food is supplied to the sharks, so that the feeder, who is located in a boat and not in the water, can vary the food delivery depending on the number of sharks. The device allows sharks to feed in a natural way, and, importantly, not associate food with humans. The food can be dispensed at an optimal rate so that there is no waste, reducing the amount of food necessary to attract and retain sharks.

### BACKGROUND OF THE INVENTION

### Field of the Invention

The invention is concerned with a device for remote feeding of animals, particularly marine animals.

### Description of the Related Art

Sharks are majestic animals. There is an increasing interest in experiencing close encounters with sharks for a variety of reasons, including recreational reasons, curiosity, promoting shark conservation, behavioral observation, and scientific study. However, despite their reputation, most sharks are shy and avoid contact with humans. Only after over months or years of work does it become possible to develop a scenario in which humans and sharks can peacefully interact. The first step in this process is to establish a regular schedule of offering a food supply to the sharks, so that the sharks assemble predictably in time and location. Sharks are intelligent. Over time, the sound of a particular boat engine is recognized by sharks as a dinner bell. Once sharks are habituated to visit a particular location at a particular time, the second step is to gradually introduce humans, e.g. scuba divers, around the area in which sharks gather. Over time, sharks become conditioned to accept, humans and, it has been found, even seem to enjoy interaction with humans.

Most people who condition sharks do so by hand feeding the sharks; that is, the person feeding the sharks, the “feeder”, is in the water with the sharks and typically has a crate with food and a stick or pole, and feeds the sharks one piece of food at a time. There are three reasons why this is unsafe: first, the shark associates humans with food so will expect to be fed whenever he sees a human; second, the feeder selects which species and which sharks get to eat, rather than the sharks feeding in the natural manner; and third, there is risk of injury to the feeder.

However, it is not only time consuming and labor intensive to cultivate such a relationship with sharks—it is also expensive in terms of procuring and offering fish to the sharks. It is necessary to develop a system and a device with which the optimal amount of food can be delivered at the optimal time interval for maximum effect, without the sharks associating the food with humans.

Previously, it has been found by fishermen that chumming water may attract not only sport fish but also sharks. However, scattering a large amount of food in the water at the same time may trigger aggressive feeding behavior in sharks.

It has been attempted by the present inventor to feed sharks at a slow, controlled rate at a dive site by freezing bait into a large bait ball, affectionately referred to as a chum-sickle. This has been found to work for smaller sharks, but on occasion a large shark may attempt to swallow or move away with the entire bait ball. Further, it is labor intensive to catch enough fish and then freeze them into a bait ball. Finally, with a bait ball, all the food is placed in the water at the same time. Even frozen, a bait ball may be consumed after only a few minutes. This encourages sharks to eat aggressively and then leave the site.

It has been attempted to attract sharks using chum bags—typically composed of a mesh and containing fresh or frozen chum—suspended in the water at a distance behind or below a boat. However, chum bags are designed to release fine particles and thus attract, but not to feed, sharks. Sharks may bite the mesh bag and destroy the bag or, worse, swallow pieces of the bag, which may cause health problems. In any case, sharks learn that chum bags are not a source of food, and it is not possible to develop a sustained program of shark interaction without providing incentives to the sharks.

There is thus a need for a device which can be used over and over again to feed sharks. The device should make it possible to control the rate at which food is supplied to the sharks, so that the feeder, who is located in a boat and not in the water, can vary the food delivery depending on the number of sharks. While the sharks' behavior appears aggressive to the divers, the shark competition for food only at the actual feeding device, which allows the sharks to continue in their native state allowing the more dominant sharks to eat first and, importantly, not associate food with humans. Finally, food should be dispensed at an optimal rate so that there is no waste, reducing the amount of food necessary to attract and retain sharks.

### SUMMARY OF THE INVENTION

In one embodiment, the present disclosure provides a feeding device for providing food to sharks and other predator fish and animals. In particular, the feeding device includes a chamber for containing an amount of food and a latch assembly that is operable by a user to release the food.

In one embodiment, the feeding device includes a body defining a chamber, a door at one end of the body, and a a door opening mechanism including that is configured to secure the door in a closed position and selectively release the door to an open position.

In one embodiment, the feeding device comprises: a body having a first end, a second end opposite the first end, and a chamber therebetween; a door hingedly coupled to the first end of the body, the door being transitionable between a closed position and an open position; and a a door opening mechanism including: a line retainment element coupled to the body within the chamber; a weight coupled to the door; and an actuation line having first and second ends, the first end being coupled to at least one of the door and the weight, the actuation line being releasably engageable with the line retainment element, wherein the door can be maintained in the closed position by inserting the line in the retainment element, and the door can be transitioned from the closed position to the open position by pulling on the actuation line to release the line from the retainment element.

### BRIEF DESCRIPTION OF THE DRAWINGS

FIG. 1 shows a perspective view of an exemplary feeding device;

FIG. 2 shows a detailed view of a door opening mechanism and door of the feeding device of FIG. 1;

FIG. 3 shows an exemplary method of loading the feeding device for use; and

FIG. 4 shows an exemplary method of opening the feeding device to release food.

### DETAILED DESCRIPTION OF THE INVENTION

The present disclosure generally relates to a device and method for releasing food into an environment at a location remote from a user. In one embodiment, the device is a feeding device that allows a user to release food from the feeding device when the feeding device is at a location that is a distance from a boat or other structure at the user's location. However, it will be understood that the feeding device may additionally or alternatively be used at the user's location or at a location near the user.

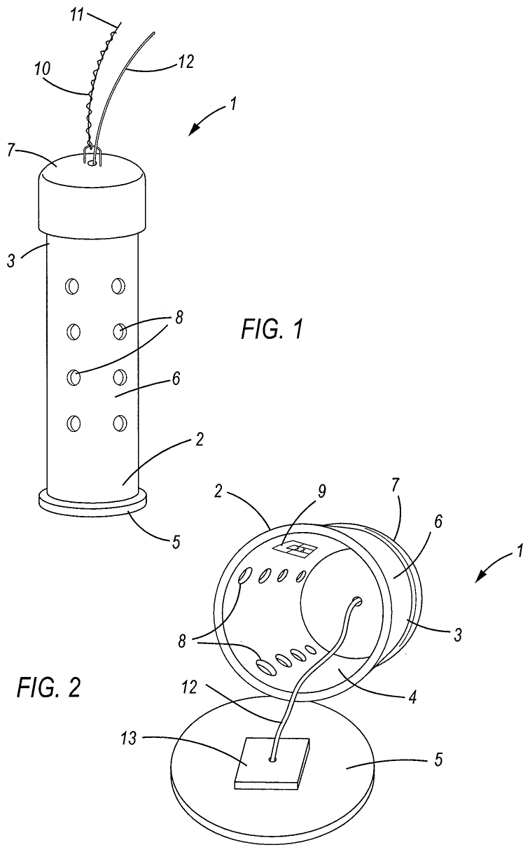

Referring now to FIG. 1, the feeding device 1 is shown. In one embodiment, the feeding device 1 generally includes a door opening mechanism and a body 6 having a first end 2, a second end 3 opposite the first end, and defining a chamber 4 therebetween (chamber 4 shown in FIG. 2). The feeding device 1 includes a door 5 that is connected to the first end 2 of the body 6 and that is transitionable between a closed position and an open position. In one embodiment, the door 5 is hingedly connected to the first end of the body. When the door 5 is in the open position, the chamber 4 is in communication with the environment external to the feeding device.

Although the feeding device is discussed herein with respect to feeding sharks, it will be understood that the feeding device may be used to feed any animal at a location that is a distance from the location of the user. For example, the feeding device may be used to feed, in addition to sharks, aquatic animals such as grouper, barracuda, rays, etc., or even terrestrial animals (for example, if the feeding device is suspended above the ground from a tree or other structure).

Continuing to refer to FIG. 1, the door 5 has an inner surface and an outer surface opposite the inner surface. When the door is in the closed position, the inner surface is at least partially within the chamber and only the outer surface is exposed to the external environment (for example, an underwater environment) and the sharks therein. In one example, both the body 6 and the door 5 have circular cross-sectional shapes each having an outer circumference. In another example, the body 6 has a circular cross-sectional shape and an outer circumference, but the door 5 has a non-circular shape and an outer diameter. However, it will be understood that any suitable combination of shapes and configurations of the body 6 and the door 5 may be used.

In embodiments wherein the body 6 has a circular cross-sectional shape, the body has an outer circumference and the door 5 has an outer circumference and/or outer diameter that is greater than the outer circumference of the body. Thus, when the door 5 is in the closed position and force is exerted on the outer surface of the door, the door will not be forced into the chamber 4, which could cause the door opening mechanism to malfunction. Rather, at least a portion of the inner surface of the door will remain in contact with a free edge of the first end 2 of the body 6.

Continuing to refer to FIG. 1, in one embodiment, the container second end 3 is a closed end. In one embodiment, the body is constructed or manufactured (such as extruded, molded, or the like) such that each of the first and second ends are open ends, and the second end is sealed by an end cap 7 that is releasably or permanently coupled to the body 6 at or proximate the second end 3 (for example, as shown in FIG. 1). For example, the end cap 7 may be coupled to the body 6 using clamps, screws, nails, threading, chemical or thermal adhesives, welding or soldering, friction fit, or any other suitable device or method for attachment that can withstand significant force. In one example, the end cap 7 is coupled to the body 6 of the feeding device such that the connection therebetween can withstand approximately 500 pounds of force. In another embodiment, the body 6 is constructed or manufactured such that the second end 3 is a closed end, and the body has an integrated second end surface (not shown).

Continuing to refer to FIG. 1, in one embodiment, the body 6 has an elongate shape, with a longitudinal axis extending between the first end and the second end. Further, in one embodiment the body 6 has a circular cross-sectional shape, although it will be understood that the body may have any suitable cross-sectional shape, such as square, rectangular, oval, polygonal, or the like. The body 6 may be composed if any non-porous material that can withstand extended periods of time being submerged in water (for example, salt or ocean water) without decomposition, warping, and/or expansion and/or contraction. For example, the body may be composed of plastic, metal, and/or glass. In one example, the body 6 is a section of polyvinyl chloride (PVC) pipe. Further, in one example, the body 6 is an approximately 36-inch (+6 inches) section of schedule 160 PVC pipe. In one embodiment, the body 6 includes at least one hole or aperture 8, such as within the sidewall of the body. The at least one hole or aperture 8 is placed, sized, and configured to not only allow water to drain from the body 6 when the feeding device is removed from the water and to allow a small amount of food to escape the body when the feeding device is in use, but also to allow the user to access at least a portion of the line retainment element (as discussed in greater detail below). In one example, the body includes a plurality of holes or apertures 8, each having a diameter of between approximately 0.5-1.5 inches. In one embodiment the size of the apertures 8 may be chosen to prevent large pieces/amounts of food or chum from escaping from the chamber 4 of the body 6 when the feeding device 1 is in use.

Continuing to refer to FIG. 1, the feeding device 1 further includes a length of chain or cable (referred to herein as a bite-resistant line 10), coupled to the second end of the body 3. In one embodiment, the bite-resistant line 10 has a first end that is coupled to the second end 3 of the body and a second end that is coupled to a length of rope, cable, or other suitable line (referred to herein as a tether line 11). In one embodiment, the first end of the bite-resistant line 10 is coupled to (for example, clipped, clamped, or otherwise secured to) the end cap 7. In another embodiment, the first end of the length of the bite-resistant line 10 is coupled to the second end surface 3. In one embodiment, the feeding device includes a rope loop, eye strap, or similar attachment element coupled to the end cap (or second end surface) and the bite-resistant line 10 is a chain, such as a ⅚″ Grade 30 or Grade 43 chain, that is coupled to the attachment element, such as by an anchor shackle (as shown in FIG. 1). Further, in one embodiment, the bite-resistant line 10 has a length of approximately four to six feet and the tether line has any suitable length that allows the feeding device to be used at a desired distance from, for example, a boat. In one example, the tether line has a length of approximately 25-65 feet.

Continuing to refer to FIG. 1, in one embodiment the door opening mechanism includes a line retainment element 9 and an actuation line 12. The actuation line 12 includes an attachment end connected to the door 5 or weight 13 that is connected to the door, a remote end that is usable by the remote user to open the door of the feeding device, as is discussed in greater detail below, and an intermediate section that is engageable with the line retainment element. In one embodiment, the actuation line 12 passes from the remote end through an aperture in the end cap 7 (or the second end face) and into the chamber, where it is engaged with at least a portion of the latch assembly to hold the door 5 in the closed position. Additionally, the actuation line 12 may be fed through one or more links of the bite-resistant line 10 to protect the actuation line from feeding sharks or other animals and to reduce the likelihood of inadvertently pulling the actuation line 12 from the line retainment element 9. In one embodiment, the actuation line 12 has a smaller diameter than the bite-resistant line 10 and the tether line 11. In one example, the actuation line 12 is parachute cord.

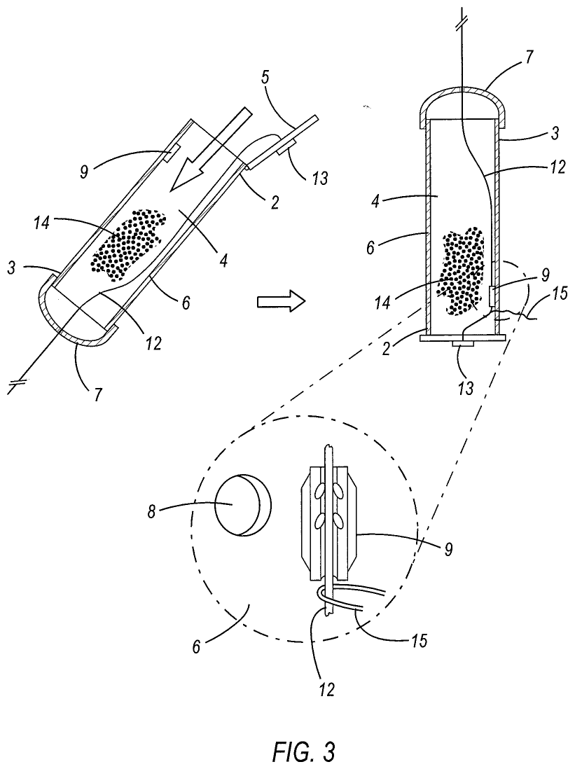

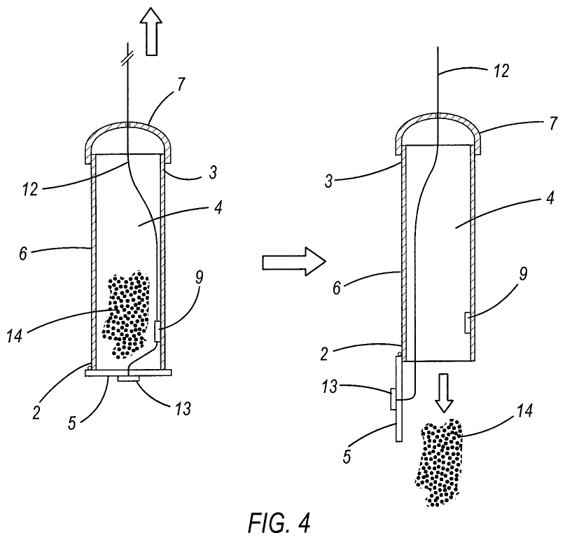

Referring now to FIG. 2, the door opening mechanism is shown in greater detail. In one embodiment, the door opening mechanism generally includes the line retainment element 9, the actuation line 12 (or at least a portion of the actuation line), and a weight 13 coupled the door 5 of the feeding device 1. In one embodiment, the weight 13 is coupled to or integrated with the outer surface of the door (for example, as shown in FIGS. 3 and 4). In this embodiment, the actuation line 12 passes through the end cap 7 (or the second end face) and into the chamber 4, then passes through the door 5 and is secured to the door 5 and/or the weight 13 (for example, the actuation line 12 is secured to both the outer surface of the door 5 and the weight 13). In another embodiment, the weight 13 is coupled to or integrated with the inner surface of the door 5 (for example, as shown in FIG. 2). In this embodiment, the actuation line 12 passes through the end cap 7 (or the second end face) and into the chamber 4. In either embodiment, at least a first portion of the attachment end of the actuation line is coupled to (such as tied to, adhered to, or the like) the weight 13 and/or the door 5, and a section of the actuation line is engaged or engageable with the line retainment element 9.

Continuing to refer to FIG. 2, the line retainment element 9 is any device configured to releasably retain at least a portion of the actuation line. Further, the line retainment element 9 is configured to release the actuation line 12 when the remote user pulls on the remote end of the actuation line 12. In one example, the line retainment element 9 is a cam cleat or a clam cleat, or any functional equivalent thereto. In one embodiment, the line retainment element is within the chamber and coupled to an inner surface of the body. In another embodiment, the line retainment element 9 is integrated with the body and extends or protrudes from the inner surface of the body into the chamber.

In another embodiment (not shown), the line retainment element includes a pin, optionally spring biased, extending between first and second bores. The weight and door are connected to a short string having a loop which is held by the pin when the door is in the closed position. The pin passes through the loop as it passes between the first and second bores. Pulling of the pin releases the loop and the door and weight are free to fall.

In yet another embodiment (not shown), the door and weight are provided with a string having an end with a loop which passes outside the body of the feeding device. The actuation line is provided with a pin. The pin connected to the actuation line passes through the loop outside the body, such that pulling on the actuation line causes the pin to be pulled from the loop, releasing the string so that the door and weight may open by gravity.

Referring now to FIG. 3, an exemplary method of loading the feeding device 1 for use is shown. During use, the feeding device 1 may be in a vertical orientation with the first end 2 below the second end 3. However, in some uses, water current, wind, or other environmental conditions may cause the feeding device to be in a horizontal position, or any position between absolutely vertical and absolutely horizontal. In some environments, the weight 13 will bias the feeding device 1 to a vertical position (as shown in FIG. 3). Thus, the method of opening the feeding device will now be discussed as though the feeding device 1 is in a vertical position.

Continuing to refer to FIG. 3, in an exemplary method of loading the feeding device 1, the feeding device is inverted such that the first end 3 of the body 6 is above, or at least level with, the second end 2 of the body. The actuation line 12 is disengaged from the line retainment element 9 and the door 5 is opened to expose the chamber 4. The user then places food 14 (for example, fresh, frozen, and/or partially frozen chum) inside the chamber and closes the door 5 against the free edge of the first end 2 of the body 6. The user then engages the actuation line 12 with the line retainment element 9 inside the chamber 4. In one example, the user reaches their finger into one of the apertures 8 near the actuation element, hooks the actuation line, and engages the actuation line into the retainment element. In another embodiment, a loop of string is used to pull the actuation line 12 towards the retainment element 9. However, it will be understood that the body may additionally or alternatively include a different aperture (such as an aperture larger than the apertures shown in the figures), a door, a port, or the like, through which the user may access the actuation line and line retainment element. For example, when the feeding device is inverted for loading, the amount of food used is such that the level of food is below the line retainment element (that is, does not obscure or interfere with the retainment element), thus ensuring the user can access the line retainment element for engagement of the actuation line. Once the food 14 is inside the chamber, the door 5 is closed, and the actuation line 12 is engaged with the retainment element 9, the feeding device 1 is loaded and ready for use. Optionally, the user may secure the tether line 11 to the boat or other structure.

Referring now to FIG. 4, an exemplary method of releasing food from the feeding device 1 is shown. When the user determines the feeding device 1 is properly positioned and is ready to release food 14, the user pulls or exerts a force on the remote end of the actuation line 12, which force transmits through the actuation line to the attachment end and causes the actuation line 12 to pull out of and become disengaged from the line retainment element 9. When the actuation line 12 is disengaged from the retainment element 9, gravity causes the weight 13 to pull the door 5 in a downward direction away from the free edge of the first end 2 of the body 6, thereby allowing the food 14 to fall from the chamber 4 and into the environment.

Thus, food 14 may be released from the feeding device 1 to feed sharks that have been conditioned to visit a particular location, while allowing the user and/or others to safely enter the water at a second location, such as from a boat, without having to immediately engage with the sharks. Alternatively, divers may be free to explore a dive site, and when ready, the feeding device may be lowered into the water to feed sharks. This may reduce the chances of injury while still incentivizing the sharks to remain in the area for observation and/or interaction.

Now that the invention has been described, I claim:

1. A remote feeding device for releasing food, the feeding device comprising:
a body having a first end, a second end opposite the first end, and a chamber therebetween;
a door hingedly coupled to the first end of the body, the door being transitionable between a closed position and an open position; and
a door opening mechanism including:
a line retainment element coupled to the body within the chamber;
a biasing element for biasing the door towards the open position; and
an actuation line having a remote end and an attachment end, the attachment end being coupled to at least one of the door and the biasing element, the actuation line being releasably engageable with the line retainment element, wherein
the door can be maintained in the closed position when the actuation line is held in the retainment element, and
the door can be transitioned from the closed position to the open position by pulling on the remote end of the actuation line releasing the actuation line from the retainment element.

2. The remote feeding device according to claim 1, wherein the line retainment element is a cam cleat.

3. The remote feeding device according to claim 1, wherein the biasing element is a weight.

4. The remote feeding device according to claim 1, wherein the biasing element is a spring.

5. A remote feeding device for releasing food, the feeding device comprising:
a body having a chamber and an opening;
a door hingedly coupled to the body, the door being transitionable between a first position covering the opening and a second position in which the opening is exposed; and
a door opening mechanism including:
a biasing element for biasing the door towards the open position;
a line having a first end attached to the door or biasing element and having a second end with a loop; and
an actuation line having a remote end and having a pin end, the pin end connected to a pin, wherein
the door can be maintained in the closed position when the pin extends through the loop, and
the door is free to transition from the closed position to the open position when the pin is pulled from the loop.

6. The remote feeding device according to claim 5, wherein the biasing element is a weight.

7. The remote feeding device according to claim 6, wherein the biasing element is a spring.
